(19) United States
(12) Patent Application Publication
(10) Pub. No.: US 2007/0121452 A1
(43) Pub. Date: May 31, 2007

(54) Test disc and drive verification method

(75) Inventors: Morio Nakatani, Ichinomiya-City (JP); Katsuki Hattori, Kiryu-city (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/602,298

(22) Filed: Nov. 21, 2006

(30) Foreign Application Priority Data
Nov. 25, 2005 (JP) 2005-340402 (P)

(51) Int. Cl. G11B 7/12

(52) U.S. Cl. 369/47.53

(57) ABSTRACT

Data of capacity of about one-severalth of full capacity of a layer 0 and a layer 1 is recorded in a test disk in a range from the layer 0 to the layer 1, and middle areas of the layer 0 and the layer 1 are expanded accordingly. This test disk is mounted on a verification target drive, and an inquiry about a starting position of the middle area, a record finishing position of user data, additional writing stating position of the disk and an additionally writable capacity (free capacity) is made with the verification target drive from an evaluation apparatus. When responding appropriately to this inquiry, the verification target drive is capable of appropriately recognizing presence/absence of an expansion of the middle area, a propriety of additional writing of this disk, the additionally writable capacity, and the additional writing starting position. Therefore, the verification target drive is determined to be capable of performing recording operation from an appropriate recording position when a write once type HDDVD is in an additionally writable state.

This application claims priority under 35 U.S.C. Section 119 of Japanese Patent Application No. 2005-340402 filed Nov. 25, 2005.

### BACKGROUND OF THE INVENTION

1. Technical Field of the Invention

The present invention relates to a test disk and a drive verification method, and particularly to the test disk and the drive verification method preferably used in performing an operation verification of a write once type optical disk drive.

2. Description of the Related Art

At present, as a write once type optical disk, further standardization of an HDDVD (High Differential Digital Versatile Disk) is progressed, wherein laser beams of a blue wavelength (wavelength of about 405 nm) is used.

An HDDVD standard includes an ROM (Read Only Memory) standard specialized for reproduction, a rewritable RW standard, and a write once type R (recordable) standard, and each standard has mutually different area format of a disk and kind of management information. The HDDVD standard so defines that the type of the disk and information of book with which the disk complies are stored in a plurality of places on the disk. Note that this standard defines a specification of a format to be applied to the disk, but does not define an operation of the drive side using the disk. Out of format information defined by the standard, which information is read to act on a drive operation is the matter of being arbitrarily set on the drive side. Namely, it does not cause a problem which part of the information in a loaded disk is used by the drive, and it is sufficient if the drive can accurately recognize a state of this disk.

Note that the standard of the write once HDDVD includes prescriptions related to the disk having double-layered recording layer. Here, in addition to a physical format of the disk, an area format and a data format of each layer are defined. In such a double layered write once HDDVD, a scan is performed from an inner circumferential side to an outer circumferential side of a first layer (layer 0) which exist first when viewing from laser beam incidence side, and when a scanned position reaches an finishing position of the first layer (outer circumferential position), the scanned position is jumped to the outer circumferential position of a second layer (layer 1), and the scan is performed from the outer circumferential side to the inner circumferential side of the second layer (layer 1) is scanned. On the layer 0, a system lead-in area, a connection area, a data lead-in area, a data area, and a middle area are set sequentially from the inner circumferential side, and on the layer 1, the middle area, the data area, a data lead-out area, the connection area, and the system lead-out area are set sequentially from the outer circumferential side. Further, a BCA (burst cutting area) is set on an innermost circumferential position of the layer 1.

Incidentally, in the standardization of the HDDVD, it was proposed that an operation verification of the HDDVD drive should be performed. The operation verification is also required in the HDDVD drive that treats the aforementioned double-layered disk.

In the verification of the recording operation of the operation verification in such a drive, an important factor is whether or not the drive is capable of recording by an appropriate signal characteristic. Another important factor is whether or not the drive is capable of appropriately recording user data and data lead-in data in each layer. Still another important factor is whether or not the drive is capable of appropriately recording a terminator for finalizing the disk.

Also, in the verification of a reproduction operation, the important factor is whether or not the drive is capable of appropriately performing data reproduction from the inner circumference to the outer circumference of the disk on each layer. In the HDDVD, in its manufacturing process, it is estimated that a warpage is generated on a surface of the disk from the inner circumferential part to the outer circumferential part of the disk. Meanwhile, since the wavelength of a laser beam has been made to be shorter, a tilt generated between a reproducing laser beam and a disk surface has a large influence on reproduction characteristics. Generally, the warpage of the disk surface becomes larger toward the outer circumferential part. Accordingly, here, the verification of the reproduction operation in a vicinity position of the outer circumferential part is particularly important. In addition, in the verification of the reproduction operation, it is also important whether or not the drive is capable of smoothly reproducing the data held in the BCA and the system lead-in area.

Further, in the verification of the reproduction operation, it is important whether or not the drive is capable of acquiring a newest RMD (Recording Management Data) recorded in the data lead-in area and whether or not the drive is capable of appropriately recognizing a propriety of the additional writing of this disk, a record finishing position, an additional writing starting address and an additionally writable free capacity.

Particularly, in the double-layered write-once type HDDVD, its standard defines that a size of the middle area is expandable. In this case, the drive must appropriately recognize presence/absence of an expansion of the middle area and how far the middle area is expanded. When such a recognition is inappropriate, although the middle area is expanded, the drive regards the expanded area as a data area and records user data in this area. As a result, such a phenomenon possibly occurs as erroneously recording the user data in an expanded range of the middle area. In this case, the data recorded in the expanded range of the middle area is not reproduced by the drive that operates appropriately other than this drive. In addition, since the expanded range of the middle area is crushed by erroneous recording of the user data, a normal test recording operation can not be performed in a drive test zone (test writing area for setting laser power) set in the middle area.

Therefore, in the verification of the drive that treats the double-layered write once type HDDVD, an important factor is whether or not the drive is capable of appropriately recognizing the presence or absence of the expansion of the middle area and the range of the expansion.

Japanese Patent Laid Open No. 2000-306244 (patent document 1) discloses that the verification of the drive is performed by using a test disk. However, a verification method of the patent document 1 can not respond to the verification of the drive that treats the aforementioned double-layered write-once type HDDVD.

In the write-once type disk, once-recorded data can not be rewritable. Therefore, every time the user additionally writes, management information such as an RMD is additionally written. Therefore, a plurality of RMDs exist in the disk, with an initial RMD recorded as it is. However, a method disclosed in the patent document 1 can not respond to the verification whether or not the drive is capable of accurately recognizing a newest RMD. Also, the method of this document cannot verify whether or not the drive can accurately recognize the disk in which the middle area is expanded.

In the verification of this drive, a specific and a plurality of verification items exist. Therefore, it is necessary to perform the verification of various recording/reproduction operations in the same drive. By appropriately performing such a verification, compatibility between drives is maintained.

### SUMMARY OF THE INVENTION

An object of the present invention is to provide a drive verification method capable of smoothly performing verification in a double-layered write once type HDDVD, such as whether or not a HDDVD drive is capable of performing data recording by appropriate signal characteristics, whether or not appropriately recording data lead-in data, appropriately recording user data on each layer, and further appropriately recording a terminator for finalizing a disk.

Another object of the present invention is to provide a drive verification method and a test disk used therefore capable of smoothly performing verification in the double-layered write once type HDDVD, such as whether or not the HDDVD drive is capable of appropriately performing data reproduction from each layer and smoothly reproducing the data held in a BCA and a system lead-in area.

In addition, still another object of the present invention is to provide a drive verification method and a test disk used therefore capable of performing verification to the double-layered write once type HDDVD, such as whether or not the HDDVD drive is capable of acquiring a newest RMD recorded in a data lead-in area, appropriately recognizing a propriety of the recording of this disk, a record finishing position, an additionally writing starting address, and an additionally writable free space from this RMD or other information, and appropriately recognizing presence or absence of an expansion of a middle area and a range of the expansion.

Further, still another object of the present invention is to perform verification of the recording operation and the reproduction operation of the drive that treats the double layered write once type HDDVD by small numbers of disks as much as possible, thereby reducing a cost and shortening a verification time. Compatibility is maintained between the drives that have undergone verification based on the present invention, in a range generally required for the recording operation and the reproduction operation of the double-layered write once type HDDVD. The object of the present invention is to efficiently confirm that the compatibility can be maintained between drives as described above, at a low cost and in a short period of verification time as much as possible.

A first aspect of the present invention relates to a drive verification method performing verification of an optical disk drive that treats a write once type optical disk having double recording layers in a lamination direction. The drive verification method includes a recording step of recording test data from a first recording layer to a second recording layer and further recording terminator data in an unrecorded write once type optical disk having double recording layers in the lamination direction, by using a verification target drive, without expanding a middle area outside of each data area of the first recording layer and the second recording layer, while allowing a free capacity to be remained in a terminal part of the data area of the second recording layer, a first determination step of acquiring a signal characteristic of the write once type optical disk recorded according to the recording step and determining a property of the signal characteristic thus acquired, by using an evaluation apparatus, a second determination step of acquiring the test data from the write once type optical disk recorded according to the recording step and determining a property of a content of the test data thus acquired, by using the evaluation apparatus, and a third determination step of acquiring the terminator data from the write once type optical disk recorded according to the recording step and determining a property of the terminator data thus acquired, by using the evaluation apparatus.

According to the drive verification method of this aspect, verification is performed whether or not the verification target drive is capable of performing data recording by appropriate signal characteristics, appropriately recording user data from the first recording layer to the second recording layer, and appropriately recording the terminator data in the data area of the second recording layer.

In the drive verification method of this aspect, the recording step can include a step of recording data lead-in data in accordance with a recording state of the test data and the terminator data in the unrecorded write once type optical disk. At this time, the drive verification method is further adapted to include a fourth determination step of acquiring the data lead-in data from the write once type optical disk recorded according to the recording step and determining a property of a content of the data lead-in data thus acquired, by using the evaluation apparatus. Thus, the verification is performed whether or not the verification target drive is capable of further appropriately recording the data lead-in data.

A second aspect of the present invention relates to a test disk used in an operation verification of an optical disk drive that treats a write once type optical disk having double recording layers in a lamination direction. The test disk includes first and second recording layers disposed in the lamination direction and to which a data format for the write once type optical disk is respectively applied. Herein, test data is recorded from a head of a data area of the first recording layer to a data area of the second recording layer, so as to fill a full capacity of the data area of the first recording layer and a prescribed capacity of a disk outer circumferential part of the data area of the second recording layer, and an unrecorded area is remained in the data area of the second recording layer in an additionally writable state, without recording therein a terminator data indicating a non-additionally writable state.

When the test disk according to this aspect is used, since the test data is recorded so as to fill the total capacity of the data area of the first recording layer and a prescribed capacity of the disk outer circumferential part of the data area of the second recording layer, the verification is performed whether or not the verification target drive is capable of appropriately reproducing the data of both of the first and second recording layers. Note that the drive passed this verification is estimated to be capable of appropriately reproducing an inner circumferential area also having a better reproduction characteristic than an outer circumferential area. Therefore, it is confirmed that the user data can be appropriately reproduced from an arbitrary position of the data area in a range from the first recording layer to the second recording layer.

In addition, when using the test disk according to this aspect, the free capacity is remained in the second recording layer in an additionally writable state, without recording the terminator data indicating the non-additionally writable state. Therefore, the verification is performed smoothly whether or not the verification target drive is capable of appropriately recognizing the propriety of the additional writing of this disk, the additional writing starting address, and the additionally writable free capacity.

The test disk according to this aspect is further adapted to dispose a burst cutting area at an innermost circumferential position of the second recording layer, for holding the information by allowing this recording layer to intermittently disappear in a disk circumferential direction. With this structure of the test disk, it is possible to verify the reproduction characteristic of the verification target drive at the disk innermost circumferential position and also verify whether or not this drive is capable of smoothly reproducing the burst cutting area where data is recorded in a system different from that of the user data.

Further, the test disk according to this aspect is adapted to dispose the system lead-in area for holding prescribed information by pit sequence, in the inside of the data area of the first recording layer. With this structure of the test disk, it is possible to verify the reproduction characteristic of the verification target drive at the disk inner circumferential position and also verify whether or not this drive is capable of smoothly reproducing the system lead-in area where data is recorded in a form different from that of the user data.

A third aspect of the present invention relates to a drive verification method performing verification of an optical disk drive that treats a write once type optical disk having double recording layers in a lamination direction, by using a test disk. Herein, an operation verification of a drive is performed by using the test disk according to the second aspect. The drive verification method includes a first step of reading the test data from the test disk by using a verification target optical disk drive, and determining a property of the test data, a second step of acquiring from the test disk an additionally writing starting address for further additionally writing data by using the verification target optical disk drive, and determining a property of the additionally writing starting address, and a third step of acquiring the free capacity which is set in the additionally writable state from the test disk by using the verification target optical disk drive, and determining a property of this free capacity. According to the drive verification method of this aspect, the same advantage as that described in the aforementioned second aspect is exhibited.

A fourth aspect of the present invention relates to a test disk used for an operation verification of an optical disk drive that treats a write once type optical disk having double recording layers in a lamination direction. The test disk includes first and second recording layers disposed in the lamination direction and to which a data format for the write once type optical disk is applied respectively. Herein, a middle area outside of each data area of the first recording layer and the second recording layer is expanded to a disk inner circumferential side respectively, and test data is recorded from the first recording layer to the second recording layer so as to fill a full capacity of each data area of the first recording layer and the second recording layer.

By using the test disk according to this aspect, it is possible to smoothly verify whether or not the verification target drive is capable of appropriately recognizing the presence and absence of the expansion of the middle area and the range of the expansion. In addition, since the test data is recorded in the range from the first recording layer to the second recording layer so as to fill the full capacity of the data area of the first recording layer and the data area of the second recording layer, it is possible to verify whether or not the verification target drive is capable of appropriately recognizing a state of the disk, such as whether or not it is in an additionally writable state or in a non-additionally writable state.

A fifth aspect of the present invention relates to a drive verification method performing verification of an optical disk drive that treats a write once type optical disk having double recording layers in a lamination direction by using a test disk. Herein, an operation verification of a drive is performed by using the test disk according to the fourth aspect. The drive verification method includes a first step of acquiring a record finishing position of the test data from the test disk by using a verification target optical disk drive, and determining a property of this record finishing position, a second step of acquiring a starting position of the middle area from the test disk by using the verification target optical disk drive, and determining a property of this starting position, and a third step of acquiring a finalized state from the test disk by using the verification target optical disk drive, and determining a property of this finalized state. According to the drive verification method of this aspect, the same advantage as that described in the aforementioned fourth aspect is exhibited.

In the drive verification method in this aspect, the test data of a prescribed number of files can be recorded in the test disk. In this case, the aforementioned drive verification method is adapted to have the fourth step of acquiring the number of recording files from the test disk by using the verification target drive, and determining the appropriateness of the recording files. With this structure of the test data, the verification is performed whether or not the verification target drive is capable of appropriately recognizing the number of files recorded in the disk.

As described above, according to the present invention, by using only three disks such as an unrecorded write once type optical disk and two test disks, it is possible to smoothly determine a propriety of the recording/reproducing operation of the verification target drive through a plurality of items. Namely, according to the present invention, the advantage is exhibited, such that the verification through a plurality of items can be efficiently performed by using only three disks, for a short period of time, at a low cost, and by a simple work. Then, as to the drives passed the verification, the mutual compatibility is satisfied in a range of required items.

### BRIEF DESCRIPTION OF THE DRAWINGS

The aforementioned object and other object and new characteristics will be more completely clarified when collated with the embodiments as will be described hereafter with reference to the appended drawings.

FIG. 1 shows a layer structure of an HDDVD according to an embodiment;

FIG. 2 shows an area division of the HDDVD according to an embodiment;

FIG. 3 shows a part of a data format of the HDDVD according to an embodiment;

FIG. 4 shows a part of the data format of the HDDVD according to an embodiment;

FIG. 5 shows the data format of a test disk 10 according to an embodiment;

FIGS. 6A and 6B are flowcharts showing a manufacturing method of the test disk 10 according to an embodiment;

FIG. 7 shows the data format of a test disk 30 according to an embodiment;

FIGS. 8A and 8B are views explaining the data format used in verification of a recorded state according to an embodiment;

FIG. 9 is a flowchart showing a verification method (verification of a recording operation) of a target drive according to an embodiment;

FIG. 10 is a flowchart showing a verification method (verification of a reproduction operation using the test disk 10) according to an embodiment; and

FIG. 11 is a flowchart showing the verification method (verification of the reproduction operation using the test disk 30) of the target drive according to an embodiment.

### DESCRIPTION OF PREFERRED EMBODIMENTS

Hereafter, preferred embodiments of the present invention will be explained with reference to the drawings. Note that in these embodiments, the present invention is applied to a test disk and a verification method for verifying a drive apparatus that treats a double-layered write once type HDDVD (hereafter, referred to as simply “write once type HDDVD”) having two layers of recording layers.

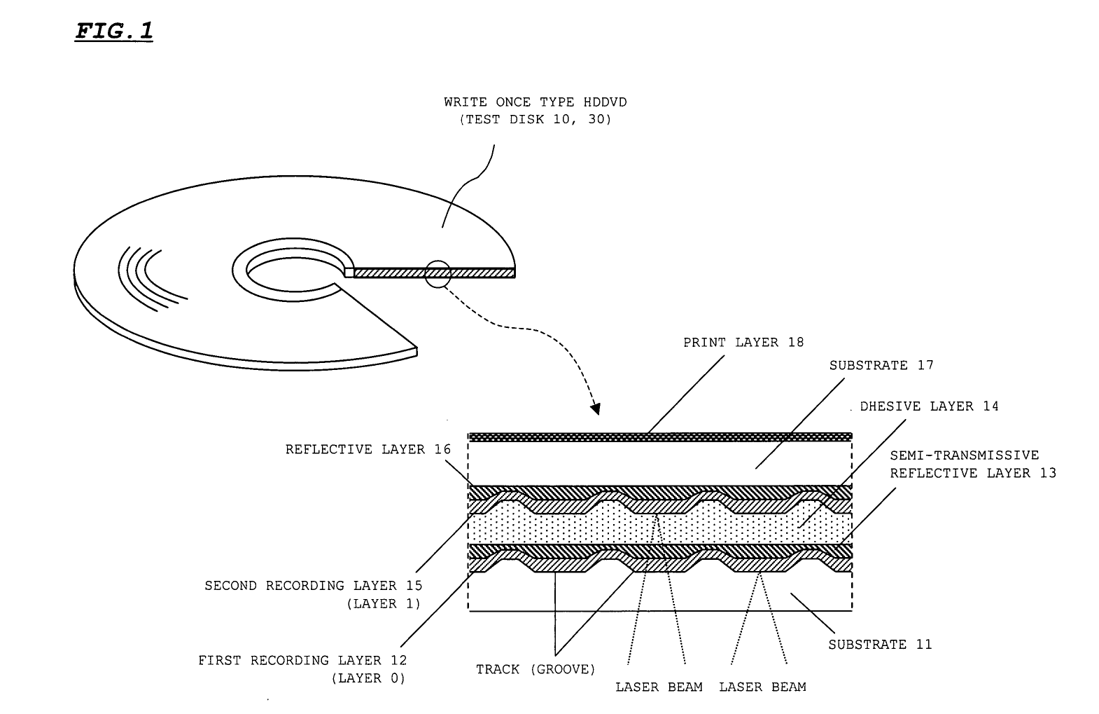

First, FIG. 1 shows a constitution of the write once type HDDVD according to an embodiment. As shown in FIG. 1, the write once type HDDVD is constituted in such a way that a substrate 11, on which a first recording layer 12 and a semi-transmissive reflective layer 13 are laminated, and a substrate 17, on which a second recording layer 15 and a reflective layer 16 are laminated, are affixed together through an adhesive layer 14, and further a print layer 18 is formed thereon.

The substrates 11 and 17 are composed of polycarbonate. It is preferable to select a material easy to transmit a laser beam having wavelength of about 400 nm used in an HDDVD drive, as a substrate material. A biodegradable material such as polyolefin and polylactic acid can also be used as the substrate material.

These substrates 11 and 17 are formed by injection molding using a stamper having track patterns (pit and groove) of a disk. The track patterns on the stamper are transferred to the surface of the substrates 11 and 17. Both of the substrates 11 and 17 have thickness of 0.6 mm.

The first recording layer 12 and the second recording layer 15 are constituted of an organic dye material. This organic dye material is a so called Low-to-High type organic dye material in which a reflectance of a recording mark part is higher than the reflectance of an unrecorded part. In addition to the Low-to-High type organic dye material, a so called High-to-Low type organic dye material can also be used in which the reflectance of the recording mark part is lower than the reflectance of the unrecorded part. However, the material used in the recording layers 12 and 15 is limited to a non-rewritable type. Also, the material of the recording layer may be the material of a phase change type, and may be Pd—CU, Co system, Ag—Pd—Cu, etc. These recording layers 12 and 15 are formed by a method such as sputtering.

The semi-transmissive reflective layer 13 is formed of a material that allows a laser beam to semi-transmit therethrough, the laser beam having the wavelength of 400 nm used in an HDDVD drive. Also, the reflective layer 16 is formed of a high reflective material such as Ag. In addition, Al and Pt, etch having high reflectance can also be used for the laser beam having the wavelength of about 400 nm. The semi-transmissive reflective layer 13 and the reflective layer 16 are formed by sputtering.

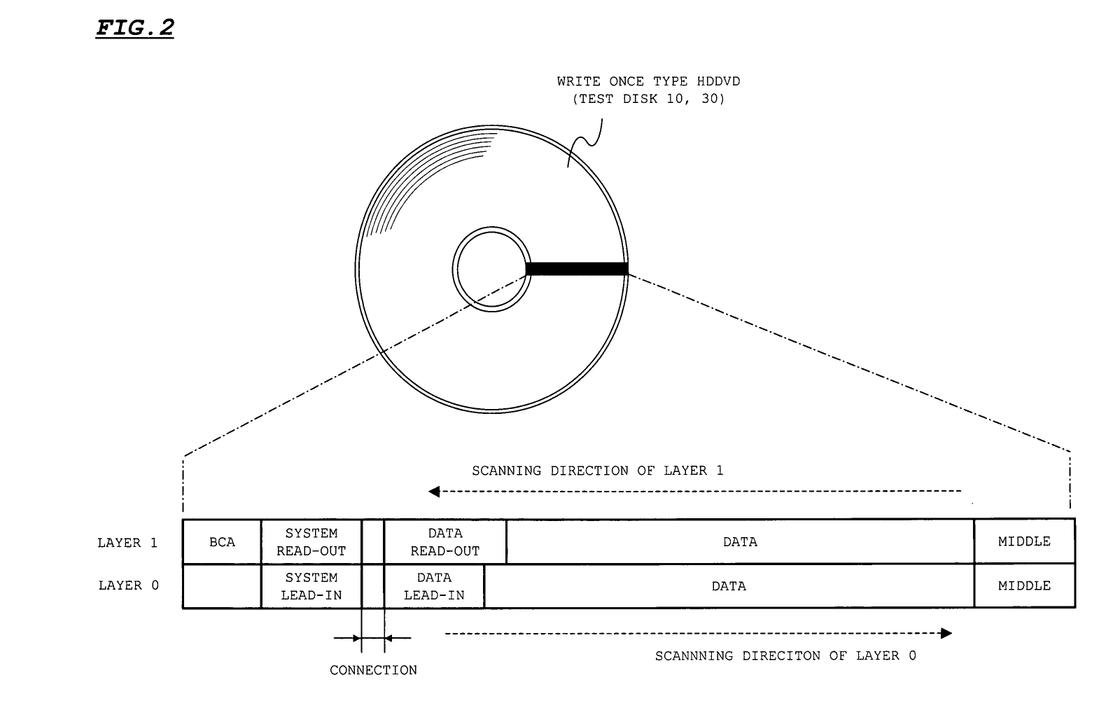

FIG. 2 shows an area format of the write once type HDDVD. A layer 0 (the first recording layer 12) is divided into a system lead-in area, a connection area, a data lead-in area, a data area, and a middle area sequentially from a disk inner circumferential side. Also, a layer 1 (the second recording layer 15) is divided into a burst cutting area (BCA), a system lead-out area, the connection area, a data lead-out area, the data area, and the middle area sequentially from the disk inner circumferential side. Note that the BCA is not disposed on the layer 0. The recording layer 12 and the semi-transmissive reflective layer 13 stay as they are in a BCA corresponding area of the layer 0.

Prescribed information is recorded in the BCA in a format of following a standard concerning the write once type HDDVD having double-layered recording layer (referred to as “double-layered HDDVD-R standard” hereafter). Specifically, by allowing a flat second recording layer 15 and the reflective layer 16 to intermittently disappear in a disk circumferential direction, the information such as a BCA_ID and a book number of a written standard on which the test disk is based is recorded. Note that disappearance of the second recording layer and the reflective layer 16 occurs by burning/cutting them by using a high power laser, for example.

When a beam spot is located on the BCA while rotating the disk, light and shade are formed in its reflective light, in accordance with a disappeared part and a non-disappeared part of the second recording layer 15 and the reflective layer 16. By demodulating a change of the aforementioned light and shade, the information recorded in the BCA is reproduced.

Prescribe information is recorded in the system lead-in area in the format of following a double-layered HDDVD-R standard. Specifically, by arranging the pit sequence in a spiral shape on the first recording layer 12, the information concerning physical parameters of this HDDVD (pit size and track pitch and so forth) is recorded. The groove is not formed in the system lead-in area, and only the pit sequence is formed. These pits are added during preparing the stamper.

In the connection area, both of the layers 0 and 1 are formed in flat mirror faces.

Spiral-shaped grooves are formed in the data lead-in area, the data area, and the middle area of the layer 0. Various data is recorded on these grooves in the format of following the double-layered HDDVD-R standard. When the test disk is formed by using a blank write once type HDDVD, the data having a structure as will be described later is recorded on the unrecorded groove. In addition, when a recorded state of the drive is verified, the data as will be described later is recorded on the groove by the verification target drive.

The spiral-shaped groove is also formed in the data lead-in area, the data area, and the middle area of the layer 1. However, this groove is turned in an opposite direction to the groove of the layer 0. Various data is recorded in this groove in the format of following the double-layered HDDVD-R standard. When the test disk is formed by using the blank write once type HDDVD, the data having the structure as will be described later is recorded on the unrecorded groove. Also, when the recorded state of the drive is verified, the data as will be described later is recorded on the groove by a verification target drive.

Note that in the write once type HDDVD, the data is recorded only on the groove, and therefore a land between grooves is formed in a size narrower, because the data is recorded only on the groove. The groove meanders (wobbles) in a diameter direction of the disk. A physical address is held by this wobbling. Note that a logical address is held in the recording data separately from this physical address.

Prescribed information is recorded in the system lead-out area in the format of following the double-layered HDDVD-R standard. In the same way as the system lead-in area, the groove is not formed in the system lead-out area, and only pit sequence is formed.

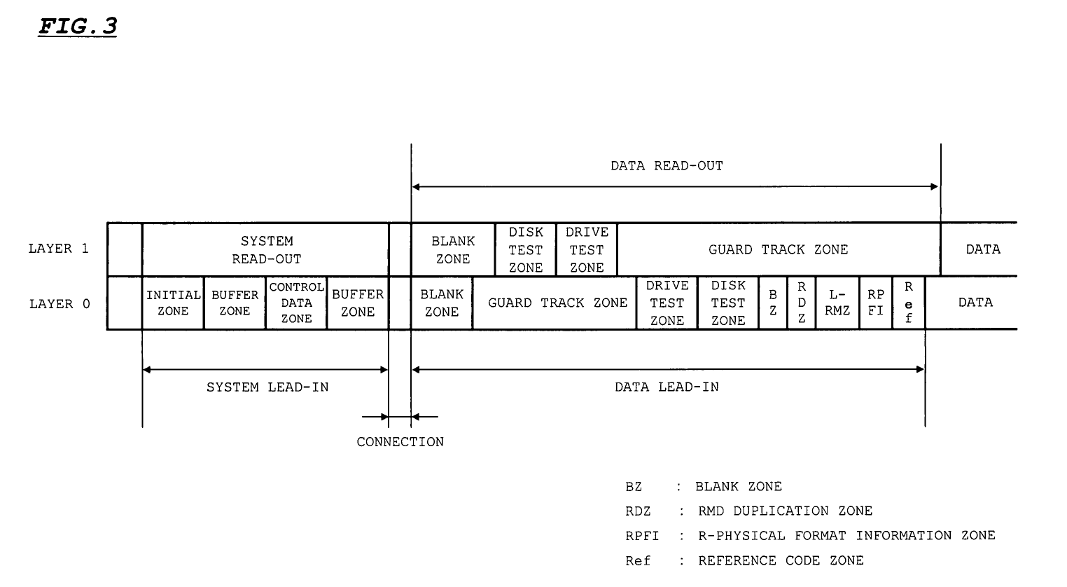

FIG. 3 shows the data format of the system lead-in area, the data lead-in area, and the data lead-out area.

As shown in the figure, drive test zones are set in the data lead-in area and the data lead-out area. During recording the user data, test writing is performed by using any one of the drive zones, and an initial value of a recording laser power is set. For example, during recording on the layer 0, a drive test zone of the data lead-in area is used, and during recording on the layer 1, a drive test zone of the data lead-out area is used.

In addition, an RMD (Recording Management Data) duplication zone (RDZ) and an L-RMZ (Lead-in Recording Management Zone) are set in the data lead-in area. The information (RMD) for managing the recorded state of the data is recorded in the L-RMZ. The address of a final recording position during preparing the RMD is included in this RMD. Note that the RMD is updated for each recording operation of the user data, and is additionally written in the L-RMZ. A capacity capable of recording a prescribed number of RMDs is allotted to the L-RMZ by following the double-layered HDDVD-R standard.

The information on the RMD such as a newest RMD effective at present and the information showing its address are recorded in the RMD duplication zone. In addition to such information, the information on the drive whereby recording is performed to this disk (Unique ID) and the information such as a time required for recording (Time Stamp) and so forth are recorded in this RMD duplication zone.

The blank zone is set in an unrecorded state. A guard track zone is filled with prescribed data. When recording is performed to the guard track zone of the layer 1 by the drive, the recording is performed to the area of the layer 0 immediately under this guard track zone, and thereafter the recording is performed to the guard track zone of the layer 1. Note that the guard track zone of the layer 1 may be set in an unrecorded state.

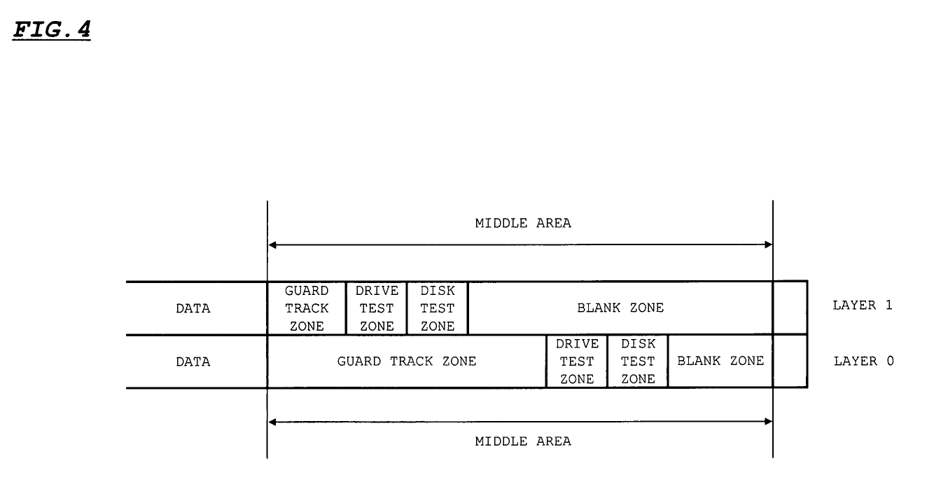

FIG. 4 shows the data format of the middle area.

As shown in the figure, the drive test zone is also set in the middle area. Normally, the drive test zone set in the data lead-in area and the data lead-out area is used for the test writing during setting the laser power. This is because disk characteristics (such as a characteristic of the recording layer) are more stable than those of the disk inner circumferential part. However, the drive test zone of the middle area is sometimes used, depending on the drive.

Note that when various kinds of data are recorded in the layer 0 and layer 1, a header such as a data ID is assigned for each frame. Here, the data ID includes attribute information (area type) showing to which of the data lead-in area, the data area, the middle area, and the data lead-out area, the data is belong.

Note that in the double-layered write once type HDDVD according to this embodiment, it is so defined by the double-layered HDDVD-R standard that the area of the layer 0 immediately under the layer 1 must be set in a recorded state without fail when the data recording is performed to the layer 1. This is because an optical characteristic of the layer 1 is largely changed depending on whether or not the layer 0 is set in the recorded state or in the unrecorded state. Namely, when the recording is performed to the layer 1, the area of the layer 0 just under the layer 1 must be set in the recorded state, and during the progress of recording in the layer 1, the layer 0 is changed from the recorded state to the unrecorded state, or from the unrecorded state to the recorded state, to prevent a large change of the optical characteristic on a border of these states. Thus, the recording is performed in the layer 1 by a stable optical characteristic.

Note that the data is recorded from the inner circumferential position to the outer circumferential direction of the layer 0, and thereafter, when the recording to the layer 0 is ended, the recording is performed from the outer circumferential position to the inner circumferential direction of the layer 1.

The capacity of the middle area is usually set to be a previously determined amount at an outermost circumferential position of each layer. In addition, in the double-layered HDDVD-R standard, the expansion of the capacity of the middle area is granted responding to a request from a user.

For example, when the user data of small capacity is recorded by a good seek efficiency, a seek distance is shorter in the recording by using the inner circumferential part of the layer 0 and the layer 1, rather than using the inner circumferential part to the outer circumferential part of the layer 0, and a waiting time for random access becomes shorter. In this case, middle areas of the layer 0 and the layer 1 are expanded in an inner circumferential direction of the disk from the outermost circumferential position to a user data record finishing position of each layer. By this expansion, the layer 0 becomes the middle area in the middle of the total data to be recorded, and thereafter, the recording is transferred to the layer 1, and remaining data is recorded. Thus, the recording of the data is ended at a place closer to the data lead-out area as much as possible.

1. Test Disk 10

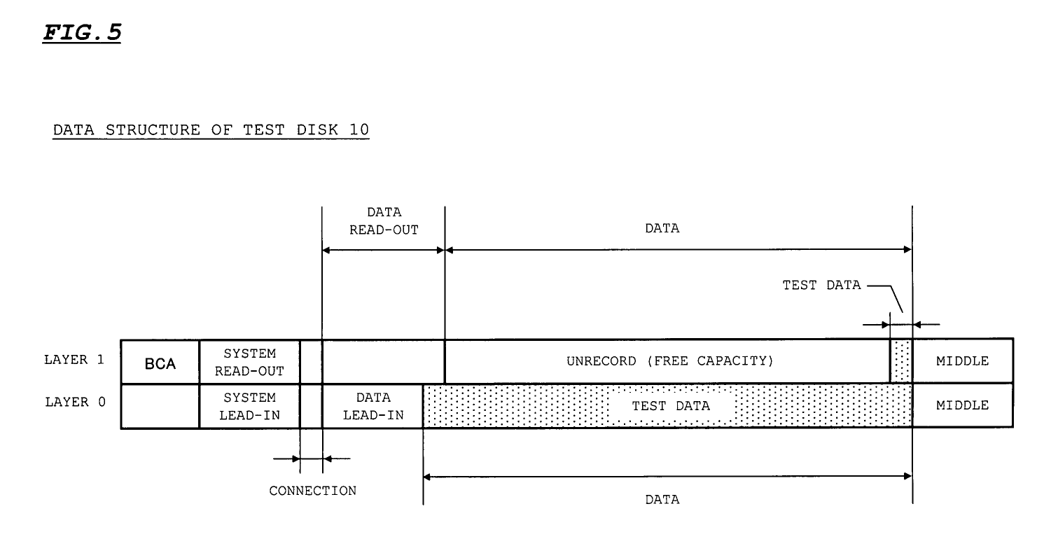

FIG. 5 shows the data format of the data of a first test disk (test disk 10) used in drive verification. This test disk 10 is generated by recording the data in the unrecorded write once type HDDVD having the aforementioned structure in the format of FIG. 5, for example. Note that this data format complies with the aforementioned double-layered HDDVD-R standard.

As shown in the figure, the test data (prescribed data) is recorded in the test disk 10, following the data lead-in. The unrecorded area (free capacity) is remained in the layer 1, and this unrecorded area is set in an additionally writable state by being finalized by the terminator. The middle area is not expanded. A small amount of test data (about 1 Mbytes) is recorded in an entire part of the data area of the layer 1 out of the entire data area of the layers 0 and 1 (capacity: 30 GB) and in a top section of the layer 2. The RMD in accordance with the recorded state of the test data is updated and recorded in the LS-RMZ of the data lead-in area.

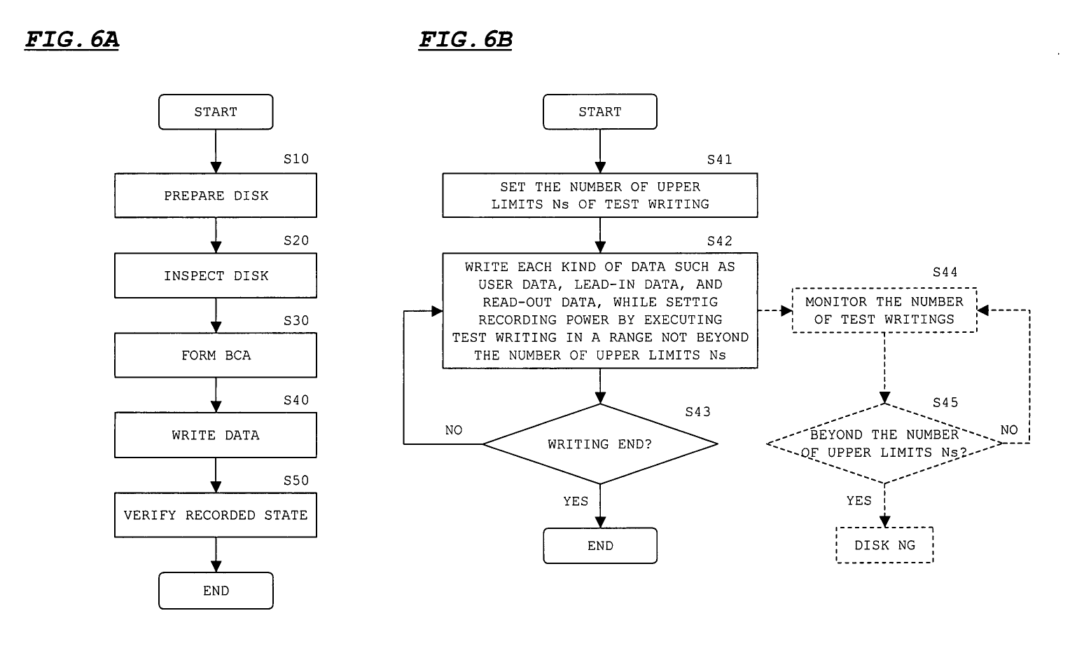

FIGS. 6A and 6B show a generation method of the test disk 10.

FIG. 6A shows a basic step of generating the test disk 10.

First, as being explained with reference to FIG. 1 as described above, the unrecorded write once type HDDVD is generated (S10). At this time, the BCA is set in an uncut state.

Next, it is determined whether or not mechanical characteristics of the unrecorded write once type HDDVD are within an adequate range (S20). Specifically, a warpage state of the disk surface and a forming state of the recording layer are inspected. Only the write once type HDDVD having an appropriate mechanical characteristic is used for a test disk generation.

Thereafter, this write once type HDDVD is irradiated with high power laser beam, and cutting of the BCA of the layer 1 is performed (S30). Further, each kind of data is recorded in the layer 0 and the layer 1 in the format shown in FIG. 5 (S40). At this time, the RMD in accordance with the recorded state of the test data is recorded in the L-RMZ of the data lead-in area. When a plurality of files are repeatedly recorded as the test data, the number of the RMDs corresponding thereto is additionally written in the L-RMZ. Note that the number of updated recordings of the RMD is set in a range not beyond the recording capacity of the L-RMZ. In addition, the information on a use state of the drive test zone is included in the RMD. Simultaneously, the information corresponding to the record of the test data is recorded in an RMD duplication zone of the data lead-in area.

However, when writing of data is ended, next, whether or not the data is appropriately recorded is determined (S50). Specifically, it is determined whether or not a PRSNR (Partial Response Signal to Noise Ratio) at the time of reproducing the test disk 10 is within a prescribed reference value or less, and whether or not each kind of bit information such as flag information is accurate. Then, only the information not determined to be faulty is selected to be the test disk that can be used in the verification of the HDDVD drive.

FIG. 6B shows a detail of S40 of FIG. 6A.

When the data is written, an upper limit value of the number of test writings that is performed for setting the recording laser power is set at Ns (S41). Then, while performing the test writing to each drive zone in a range of not beyond the number of upper limits Ns, the recording laser power is properly set, and the data having the structure shown in FIG. 5 such as user data (test data), data lead-in data, data lead-out data, middle area data, is recorded (S42, 43). Note that when the recording is performed in the layer 0, the drive test zone in the data lead-in area is used, and when the recording is performed in the layer 1, the drive test zone in the data lead-out area is used. The upper limit value Ns of the number of the test writings is set in the layer 0 and the layer 1, respectively.

The information on the use state of the drive test zone out of the RMD recorded in the RMZ is equally set on the assumption that the number of the test writings reaches the number of the upper limits Ns, even when the number of the test writings to the drive test zone of each layer does not reach the number of the upper limits Ns. Also, the number of the test writings for setting the recording laser power is monitored (S44), and when any one of the number of the test writings in each layer exceeds the number of the upper limits Ns (S45: NO), this disk is determined to be faulty, and data writing is canceled.

Note that in the flow of FIG. 6A, the BCA is added during manufacturing the test disk. However, the BCA may be formed in advance before evaluating the mechanical characteristic, etc. In addition, in the above description, a use upper limit of each drive test zone is all equally set at Ns. However, a different use upper limit number may be individually set in the drive test zone of the inner circumference/outer circumference of the layer 0 and the layer 1.

2. Test Disk 30

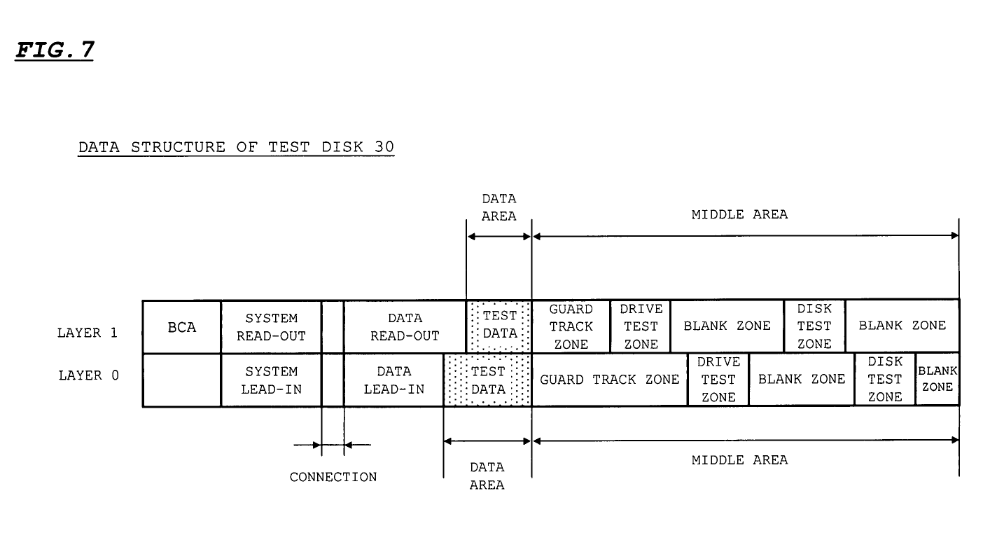

FIG. 7 shows the data format of a second test disk (test disk 30) used in a drive verification. This test disk 30 is generated by recording the data in the unrecorded write once type HDDVD, having the above-described structure, for example, in the format of FIG. 7. Note that this data format complies with the aforementioned double-layered HDDVD-R standard.

As shown in the figure, about one-severalth of total capacity of the layer 0 and the layer 1 (3 Gbytes) of test data (data of prescribed number of files) is recorded in the data area, in a range from the layer 0 to the layer 1. As shown in the figure, the middle areas of the layer 0 and the layer 1 are expanded up to the finishing position of the data area, respectively. The test data is recorded in an entire data area of the layer 1, without allowing the unrecorded free capacity to be remained. Although not finalized by the terminator, the disk is set in a non-additionally writable state, because the free capacity is not remained in the layer 1. The newest RMD of the lead-in area includes non-additionally writable information (flag).

The middle areas of the layer 0 and the layer 1 are expanded as described above, and the drive test zone of each layer in the middle area is shifted in an inner circumferential direction. Note that the disk test zone of each layer in the middle area is set at the same position as the position (address) of not expanding the middle area. Therefore, blank zones are set in the drive test zone and the disk test zone of each layer in the middle layer.

At this time, the blank zone is set in the position of the layer 0 corresponding to the position immediately under the disk test zone of the layer 1. As described above, in the double-layered write once type HDDVD, when the recording of data is performed to the layer 1, the double-layered HDDVD-R standard defines that the area of the layer 0 immediately under the layer 1 must be set in a recorded state. However, the disk test zone is used by a disk maker, and is not used on the drive side. Therefore, even when the position corresponding to the layer 0 is in an unrecorded state, no standard problem occurs.

In addition, in the L-RMZ of the data lead-in area, in the same way as the aforementioned test disk 10, the RMD corresponding to the recorded state of the test data is updated and recorded. As described above, the newest RMD includes the information (flag) showing the non-additionally writable state. Also, the newest RMD includes the information (flag) showing the expansion of the middle area and a starting address of the middle area. Here, the starting address of the middle area refers to the starting address of the middle area set in the layer 0.

This test disk 30 is generated in the same step as shown in FIGS. 6A and 6B. Note that in this case also, as shown in FIG. 6B, the upper limit value of the number of test writings is set to each layer, and while performing the test writing in the range of the number of the upper limits, the data of the format as shown in FIG. 7 is recorded. In this case also, in the same way as the aforementioned test disk 10, the information on the use state of the drive test zone out of the RMD recorded in the RMZ is equally set on the assumption that the number of the test writings equally reaches the number of the upper limits Ns, even when the number of the test writings to the drive test zone of each layer does not reach the number of the upper limits Ns.

In addition, by setting the number of using times of the drive test zone at a prescribed number, a use state of the drive test zone is prevented from being different for each disk. Further, it is possible to create a state in which the test zone of the inner circumference of the layer 0 is mostly set in an already recorded state in a purposeful way, and the drive test zone of the middle area of the layer 0 can be recognized as the next use area. In this case, by allowing the drive to perform the recording operation, it becomes possible to confirm whether or not the drive is capable of recognizing a movement of a drive test zone position.

3. Drive Verification Method

Next, a verification method of the HDDVD drive will be explained.

<Verification of a Recorded State>

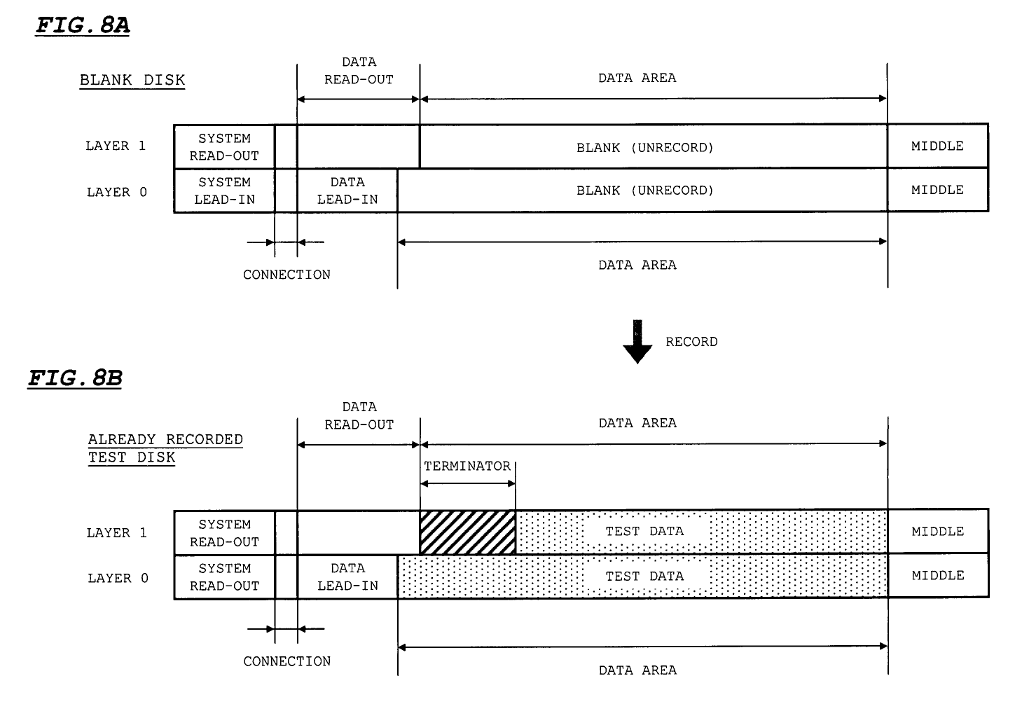

FIGS. 8A and 8B show contents of the data recorded in the unrecorded write once type HDDVD by the HDDVD drive (target drive) which is the verification target drive, during verifying the recorded state.

As shown in FIG. 8B, during the verification of the recorded state, the test data (prescribed data) of capacity (about 20 Gbytes) smaller than a full capacity of the layer 0 and the layer 1 is recorded from the layer 0 to the layer 1. In this case, the middle area of each layer is not expanded. Further, the terminator is recorded from the record finishing position of the layer 1 to the finishing position of the data area. Here, the double layered HDDVD-R standard sets an area type of a header assigned to the terminator data, to the data lead-out area. In addition, the newest RMD in the L-RMZ includes the information (flag) showing that the disk is finalized.

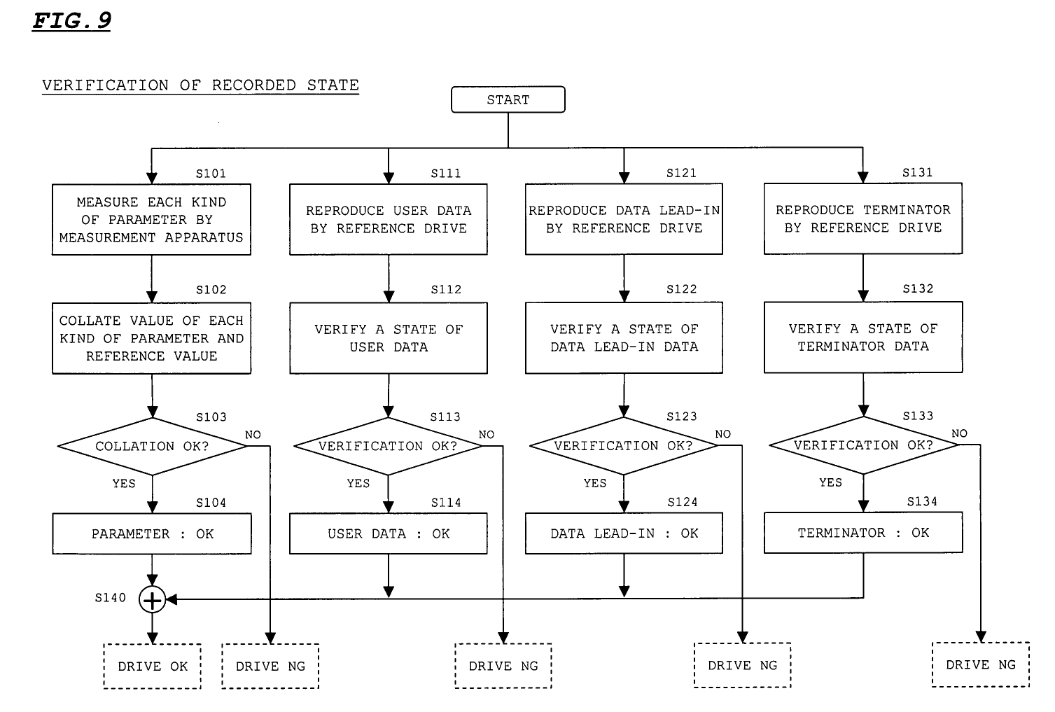

During the verification of the recorded state, the recording of data is performed by the target drive in accordance with the data format of FIG. 8B. Thereafter, it is verified whether or not the recorded state of the target drive is appropriately performed in a verification flow according to FIG. 9.

In this verification flow, first, the write once type HDDVD, to which the recording operation is performed by the target drive, is mounted on a measurement apparatus, and a PRSNR (Partial Response Signal to Noise Ratio), recording signal characteristics such as an asymmetry, and a value of each kind of parameter according to the recorded state are measured (S101). Parameter values thus measured are compared and collated with a reference value, respectively (S102). When these parameter values are not within a range of a constant reference value (S103: NO), this target drive is determined to be faulty. Meanwhile, when the parameter values are within a constant reference value (S103: YES), this target drive is determined to be capable of performing the recording operation in an appropriate range of each kind of the parameter value related to the recorded state (S104).

When the aforementioned verification step is ended, next, the write once type HDDVD, to which the recording operation is performed by the target drive, is mounted on an appropriately operating HDDVD drive (reference drive), and the verification as described below is performed.

First, when this write once type HDDVD is mounted on the reference drive, an output request command is transmitted to the reference drive from the evaluation apparatus (such as PC terminal) connected to this reference drive (S111). In response to this command, the evaluation apparatus verifies a state of the user data such as an appropriateness of the number of recorded files, and presence and absence of overlapping files, based on the user data received from the reference drive (S112). When this verification result shows a faulty state (S113: NO), this target drive is determined to be a non-appropriate drive. Meanwhile, when the verification result shows appropriateness (S113: YES), this target drive is determined to be capable of appropriately recording the user data (S114).

After the aforementioned verification flow is executed, or in parallel to the aforementioned verification flow, the output request command of the data lead-in data is transmitted to the reference drive from the evaluation apparatus (S121). In response to this command, the evaluation apparatus compares and collates the data lead-in data received from the reference drive and the data lead-in data supposed to be recorded in the write once type HDDVD, and verifies the recorded state of the data lead-in data (S122). When this verification result shows a faulty state (S123: NO), this target drive is determined to be a non-appropriate drive. Meanwhile, when the verification result shows appropriateness (S123: YES), this target drive is determined to be capable of appropriately performing the data recording in the data lead-in area (S124).

Further, after the aforementioned verification flow is executed, or in parallel to the aforementioned verification flow, the output request command of the data recorded in the terminator is transmitted to the reference drive from the evaluation apparatus (S131). In response to this command, the evaluation apparatus compares and collates the terminator data received from the reference drive and the terminator data supposed to be recorded in the write once type HDDVD, and verifies the recorded state of these data (S132). Specifically, the evaluation apparatus evaluates the appropriateness of the content of the terminator data. When this verification result shows a faulty state (S133: NO), this target drive is determined to be the non-appropriate drive. Meanwhile, when the verification result shows appropriateness (S133: YES), this target drive is determined to be capable of appropriately recording the terminator (S134).

Note that in these verifications, the information (flag) showing that the disk is finalized may also be confirmed.

As described above, when the verification of each step is ended, finally, the evaluation is made whether or not each evaluation result shows the appropriateness in steps S104, S114, S124, and S134 (S140). When all of the verification results show the appropriateness, this target drive is determined to be capable of appropriately performing the recording operation.

In the verification of this recording operation, by using one blank disk, confirmation can be made whether or not the target drive has the recording signal characteristics that comply with the standard, the information on the terminator, RMZ, and data lead-in area can be accurately recorded by using one blank disk.

<Verification 1 of Reproduction State>

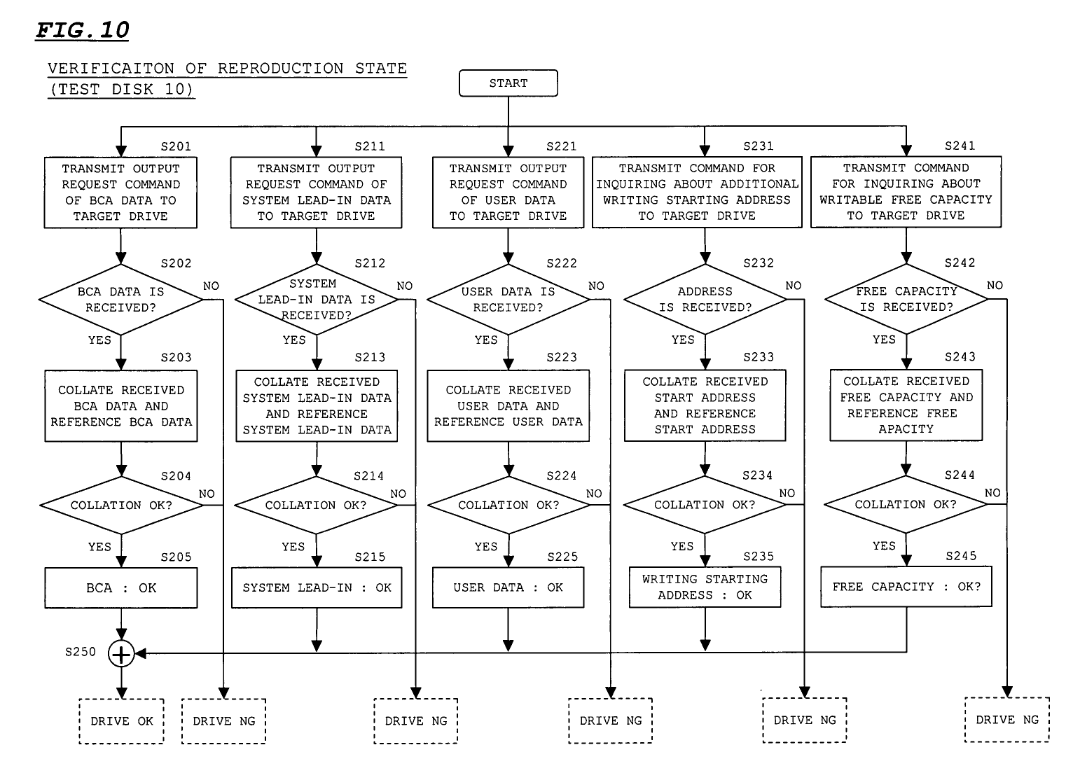

FIG. 10 shows a flowchart for verifying a reproduction state of the HDDVVD drive by using the test disk 10.

When the test disk 10 is mounted on the verification target HDDVD drive (target drive), the output request command of the BCA data (data held by the BCA) is transmitted to the target drive from the evaluation apparatus (such as PC terminal) connected to this target drive (S201). When there is no response to this command (S202: NO), this target drive is determined to be the non-appropriate drive. Meanwhile, when there is the response to the target drive (S202: YES), the evaluation apparatus collates the BCA data received from the target drive and the BCA data (reference BCA data) supposed to be recorded in the BCA of the test disk 10. When both data do not match (S204: NO), this target drive is determined to be the non-appropriate drive. Meanwhile, when the both data match with each other (S204: YES), this target drive is determined to be capable of appropriately recognizing the BCA data (S205).

After the aforementioned verification flow is executed, or in parallel to the aforementioned flow, the output request command of the system lead-in data is transmitted to the target drive from the evaluation apparatus (S211). When there is no response to this command (S212: NO), this target drive is determined to be the non-appropriate drive. Meanwhile, when there is the response from the target drive (S212: YES), the evaluation apparatus collates the system lead-in data received from the target drive and the system lead-in data (reference system lead-in data) supposed to be recorded in the system lead-in area of the test disk 10 (S213). When both data do not match (S214: NO), this target drive is determined to be the non-appropriate drive. Meanwhile, when the both data match with each other (S214: YES), this target drive is determined to be capable of appropriately recognizing the system lead-in data (S215).

Further, after the aforementioned verification flow is executed, or in parallel to the aforementioned verification flow, the output request command of the user data (test data) is transmitted to the target drive from the evaluation apparatus (S221). This command is defined as the output request command of the data recorded in a constant range from the outermost circumferential part of each data area of the layer 0 and the layer 1. In this case, the range of the data to be outputted is designated by an address. Note that in this way, instead of the request to output only partial data, the request may output entire user data.

When there is no response to this command (S222: NO), this target drive is determined to be the non-appropriate drive. Meanwhile, when there is the response from the target drive (S222: YES), the evaluation apparatus collates the user data received from the target drive and the user data (reference user data) supposed to be recorded in a designated range of the test disk 10 (S223). When both data do not match (S224: NO), this target drive is determined to be the non-appropriate drive. Meanwhile, when the both data match with each other (S224: YES), this target drive is determined to be capable of appropriately reproducing the user data (S225).

After the aforementioned verification flow is executed, or in parallel to the aforementioned verification flow, the command to inquire about the additional writing starting address (S231) is transmitted. When there is no response to this command (S232: NO), this target drive is determined to be the non-appropriate drive. Meanwhile, when there is the response from the target drive (S232: YES), the evaluation apparatus collates the additional writing starting address received from the target drive and the additional writing starting address (reference starting address) supposed to be set in the test disk 30 (S233).

Here, when both address do not match (S234: NO), this target drive is determined to be the non-appropriate drive. Meanwhile, when the both address match with each other (S234: YES), this target drive is capable of recognizing the newest RMD, and is determined to be capable of appropriately recognizing the additional writing starting address from this RMD (S235).

At this time, simultaneously, this target drive is confirmed to be capable of appropriately recognizing a finalized state of the disk. Namely, the additional writing starting address is usually outputted to this command after the drive recognizes that this disk is set in the additionally writable state. Accordingly, in response to this command, the target drive outputs the additional writing starting address. Therefore, it is confirmed that the target drive is capable of appropriately recognizing that the disk is not finalized and is set in the additionally writable state.

Further, after the aforementioned verification flow is executed, or in parallel to the aforementioned verification flow, the command to inquire about remaining capacity (free capacity) that can be additionally written is transmitted to the target drive from the evaluation apparatus (S241). When there is no response to this command (S242: NO), this target drive is determined to be a non-appropriate drive. Meanwhile, when there is the response from the target drive (S242: YES), the evaluation apparatus collates the free capacity received from the target drive and the free capacity (reference free capacity) supposed to be remained in the test disk 30 (S243).

Here, in the target drive, the free capacity is calculated based on the additional writing starting address and the last address of the data area in the layer 1. Namely, by deducting the additional writing starting address from this last address, the free capacity of this disk is obtained. Accordingly, in the target drive, when the additional writing starting address can be recognized from the newest RMD, etc, recorded in this test disk 30, the free capacity of this test disk 30 can be appropriately acquired.

In the collation of S243, when both capacity do not match (S244: NO), this target drive is determined to be the non-appropriate drive. Meanwhile, when the both data match with each other (S244: YES), this target drive is determined to be capable of appropriately recognizing the free capacity of the disk (S245).

As described above, in response to each command, when the verification is ended, finally, the evaluation is made whether or not each evaluation result is determined to be appropriate in steps S205, S215, S225, S235, and S245 (S250). Then, when all verification results are appropriate, this target drive is determined to pass the verification using the test disk 10.

As described above, according to the verification in accordance with this flowchart, the verification is smoothly performed whether or not the target drive is capable of appropriately reproducing the layer 0 and the layer 1, whether or not the record finishing position of the user data can be appropriately recognized, whether or not this disk is capable of appropriately recognizing the additionally writable state of this disk, and whether or not the additional writing starting position and the additionally writable capacity (free capacity) can be appropriately recognized. Also, along with this, the verification is smoothly performed whether or not the target drive is capable of appropriately reproducing the data held in the BCA and the system lead-in area.

Such a verification can be confirmed by using only one already recorded write once type HDDVD (test drive 10), thus making it possible to significantly efficiently perform the verification of the reproduction operation. According to this embodiment, cost required for purchasing the disk can be reduced, and a complicated work such as a disk replacement can be obviated, and the time required for the verification can be reduced.

In addition, in the aforementioned verification flow, collations in steps S203, S213, S223, S233, S243, and S250 are performed in the evaluation apparatus. However, these collations can also be performed by displaying the data received from the target drive on the monitor of the evaluation apparatus, and visually comparing this data and the reference data supposed to be recorded in the test disk 10.

Note that the user data (test data) having only a small amount of capacity is recorded in a head part of the layer 1 of the test disk 10. Therefore, the verification can not be made whether or not the drive is capable of appropriately reproducing the entire data area of the layer 1. However, as described above, in the write once type HDDVD, generally reproduction characteristics on the outer circumferential position are deteriorated, because of the warpage of the disk. Therefore, usually when the drive is capable of appropriately reproducing the head part of the layer 1, it can be estimated that the drive is also capable of reproducing the inner circumferential side where the reproduction characteristic is better than that of the outer circumferential side without needing a separate verification. Therefore, by this test disk 10 also, the verification can be made whether or not the drive is capable of appropriately reproducing from the layer 0 to the layer 1.

Also, in a case of the double layered write once type HDDVD, it is important to smoothly take over the reproduction operation from a terminal finish of the layer 0 to a beginning finish of the layer 1. In this point, in this test disk 10 also, since the user data (test data) is recorded in the head part of the layer 1, by checking whether or not the data of this part is appropriate, the verification can be made whether or not the drive is capable of smoothly taking over the reproduction operation from the terminal finish of the layer 0 to the beginning finish of the layer 1.

<Verification 2 of a Reproduction State>

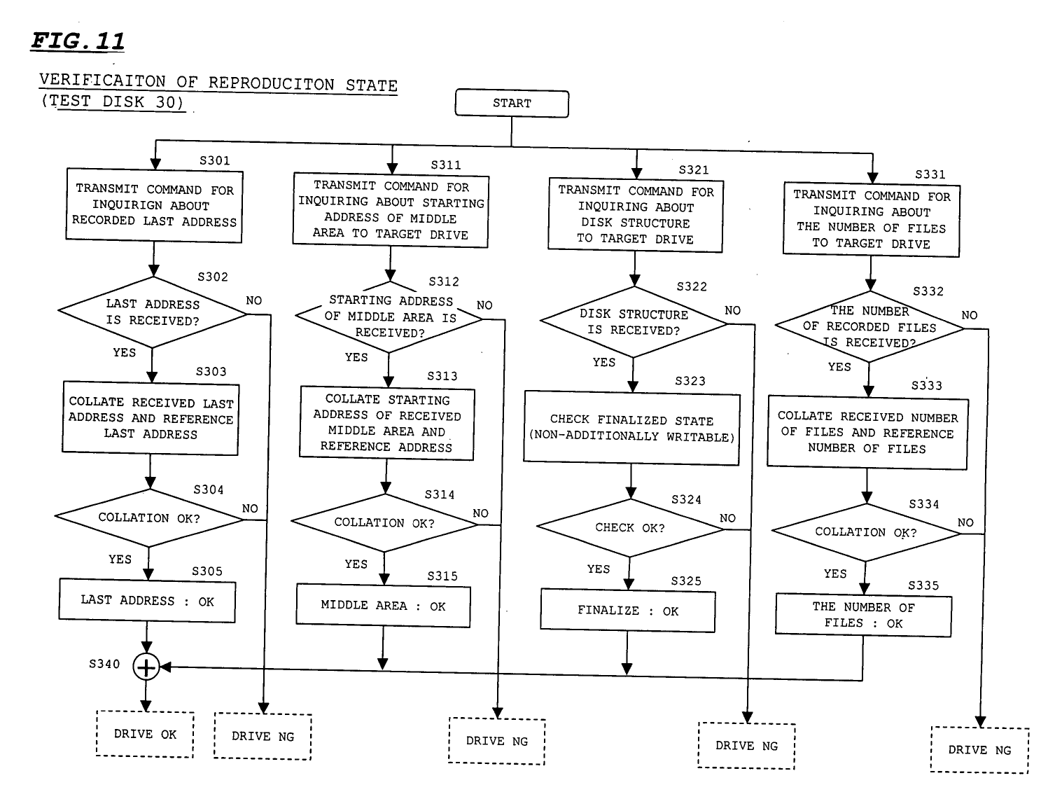

FIG. 11 shows a flowchart for verifying a reproduction state of the HDDVD drive by using the test disk 30.

When the test disk 30 is mounted on the verification target HDDVD drive (target drive), the command for inquiring about a recorded last position (address) is transmitted to the target drive from the evaluation apparatus (such as PC terminal) connected to this target drive (S301). When there is no response to this command (S302: NO), this target drive is determined to be the non-appropriate drive. Meanwhile, when there is the response from the target drive (S302: YES), the evaluation apparatus collates the recorded last address received from the target drive and the recorded last address (reference last address) supposed to be set in the test disk 30 (S303).

Here, when both address do not match (S304: NO), this target drive is determined to be the non-appropriate drive. Meanwhile, when the both address match with each other (S304: YES), this target drive is capable of recognizing the newest RMD, and is also capable of appropriately recognizing the recorded last address from this RMD (S305). Namely, it is confirmed that even when the middle area is expanded, the target drive is capable of appropriately recognizing the recorded last address that fluctuates in accordance with this expansion.

Also, after the aforementioned verification flow is executed, or in parallel to the aforementioned verification flow, the command for inquiring about the starting address of the middle area is transmitted to the target drive from the evaluation apparatus (S311). When there is no response to this command (S312: NO), this target drive is determined to be the non-appropriate drive. Meanwhile, when there is the response from the target drive (S312: YES), the evaluation apparatus collates the starting address of the middle area received from the target drive and the starting address (reference address) of the middle area supposed to be set in the test disk 30 (S313).

Here, when both addresses do not match (S314 NO), this target drive is determined to be the non-appropriate drive. Meanwhile, when the both addresses match with each other (S314: YES), this target drive is determined to be capable of recognizing the newest RMD, and is also capable of appropriately recognizing the starting address of the middle area from this RMD (S315). Namely, it is confirmed that the target drive is capable of appropriately recognizing the expansion of the middle area and the starting address of the middle area of the layer 0, which is shifted in accordance with this expansion.

Also, after the aforementioned verification flow is executed, or in parallel to the aforementioned verification flow, the command for inquiring about a disk structure of this test disk 10 is transmitted to the target drive from the evaluation apparatus (S321). When there is no response to this command (S322: NO), this target drive is determined to be the non-appropriate drive. Meanwhile, when there is the response from the target drive (S322: YES), the evaluation apparatus checks whether or not the finalized state of the information on the disk structure received from the target drive is set in the non-additionally writable state (S323).

When the finalized state received from the target drive is inappropriate (S324: NO), this target drive is determined to be the inappropriate drive. Meanwhile, when the finalized state received from the target drive is appropriate (S324: YES), this target drive is determined to be capable of appropriately recognizing the finalized state of the disk (S325).

Further, after the aforementioned verification flow is executed, or in parallel to the aforementioned verification flow, the command for enquiring about the number of files is transmitted to the target drive from the evaluation apparatus (S331). When there is no response to this command (S332: NO), this target drive is determined to be inappropriate. Meanwhile, when there is the response from the target drive (S332: YES), the evaluation apparatus collates the number of recorded files received from the target drive and the number of files (the reference number of files) that should be recorded in the test disk 30 (S333).

When both numbers of files do not match (S334: NO), this target drive is determined to be the inappropriate drive. Meanwhile, when the both numbers of files match with each other (S334: YES), this target drive is determined to be capable of appropriately recognizing the number of recorded files (S335).

As described above, when the verification for each command is ended, finally, the evaluation is made whether or not each verification result is determined to be appropriate in steps S305, S315, S325, and S335 (S340). Then, when all the verification results are determined to be appropriate, this target drive is determined to pass the verification by using this test disk 30.

As described above, according to the verification in accordance with this flowchart, the verification is smoothly performed whether or not the target drive is capable of appropriately recognizing the expansion of the middle area, appropriately recognizing the starting position of the middle area, appropriately recognizing the finalized state (non-additionally writable state), and appropriately recognizing the number of recorded files. Thus, for example, it is confirmed that an error operation such as erroneously performing additional writing in the expanded area of the middle area does not occur in this target drive, and the additional writing can be appropriately executed.

In addition, such a plurality of verifications can be confirmed by using only one already recorded write once type HDDVD (test disk 30), thus making it possible to significantly efficiently perform the verification of the target drive. According to this embodiment, the cost required for purchasing the disk can be reduced, and a complicated work such as a disk replacement can be prevented, and the time required for the verification can be reduced.

Note that in the aforementioned verification flow, collations in the steps S303, S313, 323, 333 and 340 are performed in the evaluation apparatus. However, these collations can be performed, for example, by displaying the data received from the target drive on the monitor of the evaluation apparatus, and visually comparing this data and the reference data supposed to be recorded in the test disk 30 by a user.

Note that the test disk 30 can be additionally written, and therefore when recording is performed to the target drive, the drive test zone of the test disk 30 is used. In this case, if the data structure of the test disk 30 is set in advance, so that the used drive test zone becomes the middle area, it can also be confirmed whether or not the target drive accurately recognizes that the position of the drive test zone is changed by the expansion of the middle area.

As described above, according to this embodiment, by performing the verification of the recorded state and verifications 1 and 2 of the reproduction state to the same target drive, it is possible to verify whether or not the target drive is appropriate in both of the recording operation and reproduction operation.

Particularly, by using the test disk 10, the verification can be smoothly performed whether or not the target drive is capable of appropriately reproducing the layer 0 and the layer 1, appropriately recognizing the record finishing position of the user data, appropriately recognizing that the disk is set in the additionally writable state, and appropriately recognizing the additionally writing starting position and the additionally writable capacity (free capacity), and also the verification can be smoothly performed whether or not the target drive is capable of appropriately reproducing the data held in the BCA and the system lead-in area.

In addition, by using the test disk 30, the verification can be smoothly performed whether or not the target drive is capable of appropriately recognizing the newest RMD, appropriately recognizing the expansion of the middle area, further appropriately recognizing the finalized state (non-additionally writable state), and appropriately recognizing the number of recorded files.

In this way, according to the verification method of this embodiment, the verification is performed whether or not the target drive is capable of appropriately performing the record, whether or not the target drive is capable of appropriately recognizing the finalized state of the write once type HDDVD, appropriately recognizing the additionally writable write once type HDDVD, and whether or not the target drive is capable of appropriately reproducing from the layer 0 to the layer 1, and further the verification is performed whether or not the middle area is expanded and whether or not the record is performed at the inappropriate position in the write once type HDDVD.

Accordingly, in a case of the double layered write once type HDDVD, the drive that has passed the verification method according to this embodiment is capable of suitably performing the record thereto, and the information can be appropriately reproduced from any position of this type of the write once type HDDVD. Accordingly, mutual compatibility can be held between these drives. In addition, by adopting the disk structure as shown in the aforementioned embodiment, this verification can be realized by using only three disks, thus making it possible to reduce the cost and reduce the verification time.

As described above, although various embodiments according to the present invention have been explained, the present invention is not limited to the aforementioned embodiments, and can be realized by various embodiments other than the aforementioned embodiments.

For example, in the aforementioned embodiments, in the same way as a normal write once type HDDVD, it is assumed that the test disk is generated by using the disk, with polycarbonate as a substrate material. However, the test disk may be manufactured, so as to have an additionally writable material/structure on a glass substrate. In this case, an advantage is that the problem such as a tilt, which is the problem of a polycarbonate substrate, can be reduced, and a change amount of the tilt is reduced with respect to a temperature change.

Also, in the above-described embodiment, the test disk is manufactured by recording in a blank write once type HDDVD. However, when a stamper with a changed surface structure in the groove having wobbles is manufactured in advance, then, based on this, a substrate is generated, and thereafter a reflective layer whose reflectance is adjusted to comply with the standard is formed, the test disk that complies with the double layered HDDVD-R standard can be manufactured without the step of recording. However, in this case, the disk actually used by the user and the test disk have different structures, and therefore a test result would sometimes be slightly separated from the write once type HDDVD corresponding to that actually used by the user. Accordingly, in order to make the test result comply with the write once type HDDVD actually used by the user, as shown by the aforementioned embodiment, it is preferable to manufacture the test disk by recording in the blank write once type HDDVD.

In addition, in the aforementioned embodiment, the BCA is disposed only in the layer 1. However, the BCA may be disposed in both of the layer 0 and the layer 1, and when this embodiment complies with the double layered HDDVE-R standard, the same effect as the aforementioned embodiment is exhibited.

In the aforementioned embodiment, a size of the data to be recorded is specifically shown, but the present invention is not limited thereto. For example, in the aforementioned embodiment, the size of the user data (test data) of the test disk 30 as shown in FIG. 7 is set at about 3 GB. However, this size may be changed to 10 GB or 25 GB. In this case, the content of the data to be collated in the evaluation apparatus during verification is suitably changed in accordance with this change. However, by this change, the object and the advantage of the present invention are not changed.

The embodiments of the present invention may be suitably variously changed in a range of a technical concept shown in the scope of claims of the present invention.

What is claimed is:

1. A drive verification method performing verification of an optical disk drive that treats a write once type optical disk having double recording layers in a lamination direction, comprising:
a recording step of recording test data from a first recording layer to a second recording layer and further recording terminator data in an unrecorded write once type optical disk having double recording layers in the lamination direction, by using a verification target drive, without expanding a middle area outside of each data area of said first recording layer and said second recording layer, while allowing a free capacity to be remained in a terminal part of the data area of said second recording layer;
a first determination step of acquiring a signal characteristic of the write once type optical disk recorded according to the recording step and determining a propriety of the signal characteristic thus acquired, by using an evaluation apparatus;
a second determination step of acquiring said test data from the write once type optical disk recorded according to the recording step and determining a propriety of a content of the test data thus acquired, by using the evaluation apparatus; and
a third determination step of acquiring said terminator data from the write once type optical disk recorded according to the recording step and determining a propriety of the terminator data thus acquired, by using the evaluation apparatus.

2. The drive verification method according to claim 1, wherein;
the recording step includes a step of recording data lead-in data in accordance with a recording state of said test data and said terminator data in said unrecorded write once type optical disk; and
the drive verification method further comprises a fourth determination step of acquiring said data lead-in data from the write once type optical disk recorded according to the recording step and determining a propriety of a content of the data lead-in data thus acquired, by using the evaluation apparatus.

3. A test disk used in an operation verification of an optical disk drive that treats a write once type optical disk having double recording layers in a lamination direction, comprising:
first and second recording layers disposed in said lamination direction and to which a data format for said write once type optical disk is respectively applied,
wherein test data is recorded from a head of a data area of said first recording layer to a data area of said second recording layer, so as to fill a full capacity of the data area of said first recording layer and a prescribed capacity of a disk outer circumferential part of the data area of said second recording layer, and
an unrecorded area is remained in the data area of said second recording layer in an additionally writable state, without recording therein a terminator data indicating a non-additionally writable state.

4. The test disk according to claim 3, wherein
the test disk is formed by recording the test data in an unrecorded write once type optical disk so as to fill a full capacity of a data area of a first layer and a prescribed capacity of a disk outer circumferential part of a data area of a second layer, in accordance with the data format.

5. The test disk according to claim 4, wherein
a laser power is set by performing a test writing in a range in which the number of test writings does not exceed the number of upper limits Ns set in advance, and by the laser power after set, the test data is recorded in each data area of the first layer and the second layer.

6. The test disk according to claim 5, wherein
even when the number of test writings performed for setting of the laser power does not reach the number of upper limits Ns, information (RMD) for managing a recorded state is recorded in the write once type optical disk, in a state that the number of test writings is set at Ns.

7. The test disk according to claim 3, wherein
a burst cutting area is disposed in an innermost circumferential position of the second recording layer, for holding information by allowing the recording layer to intermittently disappear in a disk circumferential direction.

8. The test disk according to claim 7, wherein
a system lead-in area is disposed in an inside of the data area of the first recording layer, for holding prescribed information by pit sequence.

9. A drive verification method performing verification of an optical disk drive that treats a write once type optical disk having double recording layers in a lamination direction, by using a test disk, the test disk comprising:
first and second recording layers disposed in the lamination direction and to which a data format for the write once type optical disk is applied, wherein test data is recorded from a head of a data area of the first recording layer to a data area of the second recording layer so as to fill a full capacity of the data area of the first recording layer and a prescribed capacity of a disk outer circumferential part of the data area of the second recording layer, and a free capacity is remained in the data area of the second recording layer in an additionally writable state, without recording therein terminator data indicating a non-additionally writable state,
wherein the drive verification method comprises:
a first step of reading the test data from the test disk by using a verification target optical disk drive, and determining a property of the test data;
a second step of acquiring from the test disk an additionally writing starting address for further additionally writing data by using the verification target optical disk drive, and determining a property of the additionally writing starting address; and
a third step of acquiring the free capacity which is set in the additionally writable state from the test disk by using the verification target optical disk drive, and determining a property of this free capacity.

10. The drive verification method according to claim 9, wherein
the determination in the first step is made by reading the test data from a prescribed range in the vicinity of each outermost circumferential position of the data area of the first recording layer and the data area of the second recording layer respectively by using the verification target optical disk drive, and checking whether or not the test data thus read matches with test data supposed to be recorded in the test disk.

11. The drive verification method according to claim 9, wherein
the test disk has a burst cutting area disposed at an innermost circumferential position of the second recording layer, for holding information by allowing the recording layer to intermittently disappear in a disk circumferential direction, and
the drive verification method comprises a fourth step of reading data recorded in the burst cutting area from the test disk by using the verification target optical disk drive, and determining a property of this data.

12. The drive verification method according to claim 11, wherein
the test disk has a system lead-in area disposed at an inside of the data area of the first recording layer, for holding prescribed information by pit sequence, and
the drive verification method comprises a fifth step of reading data recorded in the system lead-in area from the test disk by using the verification target optical disk drive, and determining a property of this data.

13. A test disk used for an operation verification of an optical disk drive that treats a write once type optical disk having double recording layers in a lamination direction, comprising:
first and second recording layers disposed in the lamination direction and to which a data format for the write once type optical disk is applied respectively,
wherein a middle area outside of each data area of the first recording layer and the second recording layer is expanded to a disk inner circumferential side respectively, and
test data is recorded from the first recording layer to the second recording layer so as to fill a full capacity of each data area of the first recording layer and the second recording layer.

14. The test disk according to claim 13, wherein
the test disk is formed by recording the test data so as to fill a full capacity of each data area of a first layer and a second layer of an unrecorded write once type optical disk, in a state of expanding the middle area in accordance with the data format.

15. The test disk according to claim 14, wherein
a laser power is set by performing a test writing in a range in which the number of test writings does not exceed the number of upper limits Ns set in advance, and by the laser power after set, the test data is recorded in each data area of the first layer and the second layer.

16. The test disk according to claim 15, wherein
even when the number of test writings performed for setting of the laser power does not reach the number of upper limits Ns, information (RMD) for managing a recorded state is recorded in the write once type optical disk, in a state that the number of test writings is set at Ns.

17. A drive verification method performing verification of an optical disk drive that treats a write once type optical disk having double recording layers in a lamination direction by using a test disk,
wherein the test disk comprises:
first and second recording layers disposed in the lamination direction and to which a data format for the write once optical disk is applied respectively, wherein a middle area outside of each data area of the first recording layer and the second recording layer is expanded to a disk inner circumferential side respectively, and test data is recorded from the first recording layer to the second recording layer so as to fill a full capacity of each data area of the first recording layer and the second recording layer, and
the drive verification method comprises:
a first step of acquiring a record finishing position of the test data from the test disk by using a verification target optical disk drive, and determining a property of this record finishing position;
a second step of acquiring a starting position of the middle area from the test disk by using the verification target optical disk drive, and determining a property of this starting position; and
a third step of acquiring a finalized state from the test disk by using the verification target optical disk drive, and determining a property of this finalized state.

18. The drive verification method according to claim 17, wherein
test data of a prescribed number of files is recorded in the test disk, and
the drive verification method comprises a fourth step of acquiring the number of files from the test disk by using the verification target optical disk drive, and determining a property of this number of files.
